(19) United States
(12) Patent Application Publication
(10) Pub. No.: US 2008/0203970 A1
(43) Pub. Date: Aug. 28, 2008

(54) Battery-powered apparatus for portable system

(75) Inventor: Feng-Min Shen, Hsin-Chu Hsien (TW)

Correspondence Address: BACON & THOMAS, PLLC, 625 SLATERS LANE, FOURTH FLOOR, ALEXANDRIA, VA, 22314, US

(73) Assignee: Phison Electronics Corp., Hsin-Chu Hsien (TW)

(21) Appl. No.: 11/711,045

(22) Filed: Feb. 27, 2007

(51) Int. Cl. H02J 7/00

(52) U.S. Cl. 320/128; 307/65

(57) ABSTRACT

The invention presents a battery-powered apparatus with an internal battery device and an external battery device for a portable system. Meanwhile the battery powered apparatus, applied to a portable system, includes a power path switching circuit having a power path multiplexer, a logic controller and a voltage detector connected to an external power supply, an internal battery device, an external battery device and the portable system, wherein the voltage detector is in response to inputting voltages of the external power supply, the internal battery device and the external battery device, and then provides the logic controller with information for determining one of the external power supply, the internal battery device and the external battery device electrically conducted to the portable system via the power path multiplexer; and a rechargeable battery charging circuit connected to the external power supply, the internal battery device, and the external battery device; and having a charging arbitrator in response to the external power supply, the internal battery device and the external battery device for determining to recharge the internal battery device and the external battery device.

### FIELD OF THE INVENTION

The present invention relates generally to a battery-powered apparatus for a portable system; and, more specifically, to a battery-powered apparatus with an internal battery device and an external battery device for a portable system thereby providing the portable system with a stable power source and recharging the battery-powered apparatus stably.

### BACKGROUND OF THE INVENTION

Over the past several years, a lot of portable systems such as wireless telephones usually consist of one base unit utilizing a great deal of power for which must be connected to a battery powered apparatus. Usually, the battery powered apparatus for the portable system could be rechargeable or not. When the battery capacity diminishes to a specific value, or when battery output voltage is at a specific marginal level, the user has to change the battery or recharge it. Meanwhile, the portable system won't provide the service during a power outage.

Accordingly, there is a need for providing an external battery powered apparatus, such that when a user forgets to recharge the battery associated with the portable system or the original battery is out of order, an external battery powered apparatus can be utilized to power the portable system. Another need is to provide an uninterruptable power supply for the base unit by utilizing extended battery when it is charged and operably associated with the base unit to power the base unit circuitry in the event of a power failure.

In U.S. Pat. No. 5,477,123, the external battery is connected between the battery connector of a portable electronic device, and the original batteries. The circuit selectively connects each of the batteries to the connector so that power flows between the connector and exactly one of the batteries. The circuit senses power flow between the selected battery and the connector, and when this power flow decreases below a threshold, the circuit selects another battery for connection to the connector. Referring to FIG. 1, it illustrates an electrical circuit with external batteries for a computer according to the prior art. As shown in FIG. 1, an electrical circuit 10 includes a connector 16 for connection to a computer and four connectors 18a, 18b, 18c and 18d respectively for connection to different batteries. Each connector includes four terminals. The connectors include power and ground terminals 20 and 21 through which electrical power flows from a battery to the computer or vice versa. Each connector also includes two signal lines 22 through which electrical signals flow to facilitate communication between computer and batteries. Meanwhile, the power is coupled from connector 16 to a selected one of connectors 18 via three relays 23, 25a and 25b. When the battery connected to connector 18a is enabled, relays 23 and 25a are in the positions illustrated in FIG. 1 and therefore, power is directly coupled from terminal 20 of connector 16 to terminal 20 of connector 18a. Signal lines 22 of connector 16 are selectively connected to one set of signals lines 22 in a connector 18a, 18b, 18c or 18d via one of four pairs of transmission gates 24a, 24b, 24c or 24d. Logical signals, which enable transmission gates 24, and control relays 23 and 25 are produced by a Johnson counter 26 as output lines Q₀, Q₁, Q₂, and Q₃. Outputs Q₀, Q₁, Q₂, and Q₃ of Johnson counter 26 are respectively coupled to transmission gates 24a, 24b, 24c and 24d. Transmission gates 24 will be enabled only when a high logic level is applied to control inputs of the transmission gates from an output of Johnson counter 26. Therefore, when Johnson counter 26 is in its initial, reset state, transmission gates 24a are enabled and transmission gates 24b, 24c and 24d are disabled. Thus, in this state signal lines 22 of connector 16 are coupled through transmission gates 24a to signal lines 22 of connector 18a, but are disconnected from signal lines 22 of connectors 18b, 18c and 18d. Similarly, when Johnson counter 26 has advanced so that its output line Q₁ is at a high logic level, signal lines 22 of connector 16 are coupled through transmission gates 24b to signal lines 22 of connector 18b, but are disconnected from signal lines 22 of connectors 18a, 18c and 18d. In the same manner, Johnson counter 26 output Q₂ enables transmission gates 24c connecting connector 18c to connector 16, and output Q₃ enables transmission gates 24d and connector 18d to connector 16.

In the '123 patent, relays 23 and 25a and 25b are also controlled by outputs Q₀, Q₁, Q₂, and Q₃ of Johnson counter 26. This control is achieved by applying current to one of two relay control coils 30 and 31, wherein relay control coil 30 controls relay 23, and relay control coil 31 controls relays 25a and 25b. Specifically, when either of outputs Q₂ or Q₃ are at a high logical state, current flows through one of diodes 32 and through a 10 kΩ resistor 33 to cause transistor 34 to turn on and draw current through relay control coil 30. When output Q₁ or Q₃ of Johnson counter 26 are in a high logical state, current flows through one of two diodes 32′ and resistor 33′ to turn on transistor 34′ and cause current flow through relay control coil 31, but when no high logical state appears on outputs Q₁ or Q₃, pull down resistor 35′ causes transistor 34′ to turn off and prevents current flow through relay control coil 31. As a result, when Q₁ or Q₃ have a high logical state, relays 25a and 25b couple signal terminals of relay 23 to connectors 18b and 18d, respectively. Otherwise, relays 25a and 25b couple signal terminals of relay 23 to connectors 18a or 18c.

By considering the above it can be seen that signal terminals 22 and power terminal 20 of connector 18a will be connected to the corresponding terminals of connector 16, if and only if, output Q₀ of Johnson counter 26 has a high logical state. Similarly, these terminals 22 of connector 18b will connect to corresponding terminals 22 of connector 16C, if and only if, output Q₁ of Johnson counter 26 has a logical state. Moreover, a high logical state on output Q₂ of Johnson counter 26 causes terminals 22 of connector 18c to connect to connector 16, and a high logical states of output Q₃ of Johnson counter 26 causes terminals 22 of connector 18d to connect to connector 16.

Circuit 10 includes a power monitoring circuit 36, which detects power flow from connector 16 to one of connectors 18a, 18b, 18c or 18d. Circuit 36 detects power flow by a 0,1Ω sense resistor 37 which is coupled between the ground terminals 21 of connectors 18a, 18b, 18c and 18d and the ground terminal of connector 16. In accordance with the operation of circuit 36, circuit 10 connects each connector 18a, 18b, 18c and 18d to connector 16. A connection between a connector 18 and connector 16 will be retained only so long as current is detected by sense resistor 37. If no current is detected, circuit 36 will cause Johnson counter 26 to advance to a subsequent state. This process will continue until all connectors 18 have been selectively connected to connector 16, at which time, Johnson counter 26 advances to a state in which its output Q₄ has a high level, so that Johnson counter 26, and circuit 10, becomes disabled and will no longer advance in response to transition on line 28. When power is initially applied to circuit 10, by inserting a battery into a connector 18, or by inserting connector 16 into computer or another portable electronic device, Johnson counter 26 is reset by a logic high level on line 27. After approximately 1 second, a logic low level is applied to line 27, so that Johnson counter 26 is no longer forced into a reset state. Thus when power is first applied to circuit 10 the battery connected to connector 18a is initially connected to connector 16. Thereafter, circuit 10 selectively connects the battery in connector 18b, 18c and 18d whenever low current levels are detected.

However, the '123 patent could not provide an electric circuit to determine the number of external batteries in series connection. When one of external batteries is out of order, the power supply system could damage the portable system. On the other hand, if the prior art provides plural external batteries in parallel connection, the recharging system could overload due to the plural batteries and each battery with different internal resistance could cause the charging-and-discharging effect among the plural external batteries. Certainly, it will cost a lot to magnify the internal battery of the portable system and it is difficult to perform that. Therefore, the prior art could not provide a battery-powered apparatus with an internal battery device and an external battery device for a portable system without introducing the above problems.

### SUMMARY OF THE INVENTION

Accordingly, the prior art is limited by the above problems. It is an object of the present invention to provide a battery-powered apparatus with an internal battery device and an external battery device for a portable system, wherein a rechargeable battery charging circuit and a power path switching circuit are introduced, thereby providing the portable system with a stable power source and recharging the battery-powered apparatus stably.

In accordance with an aspect of the present invention, the battery powered apparatus for a portable system includes a power path switching circuit having a power path multiplexer, a logic controller and a voltage detector connected to an external power supply, an internal battery device, an external battery device and the portable system, wherein in response to inputting voltages of the external power supply, the internal battery device and the external battery device, the voltage detector provides the logic controller with information for determining which one of the external power supply, the internal battery device and the external battery device is electrically conducted to the portable system via the power path multiplexer; and a rechargeable battery charging circuit connected to the external power supply, the internal battery device, and the external battery device; and having a charging arbitrator in response to the external power supply, the internal battery device and the external battery device for determining to recharge the internal battery device or the external battery device.

Preferably, the external power supply is electrically conducted to the portable system while input voltage of the external power supply is higher than a first voltage threshold; and one of the internal battery device and the external battery device is electrically conducted to the portable system while input voltage of the external power supply is lower than the first voltage threshold.

Preferably, the power path multiplexer switches the external power supply to conduct electrically to the portable system while the logic controller determines that input voltage of the external power supply restores to be higher than a second voltage threshold.

Certainly, the first voltage threshold can be lower than the second voltage threshold.

Preferably, the voltage detector further includes a first connecting terminal for connecting to the external power supply and ground; and a second connecting terminal for connecting to the external battery device and ground.

Preferably, the first voltage threshold is equal to K+0.3V, and said second voltage threshold is equal to K+0.4V, where K=VIN_{ideal}×R2/(R1+R2), VIN is the ideal inputting voltage of said external power supply, R1 is resistance between said external power supply and said first connecting terminal of said voltage detector, and R2 is resistance between ground and said first connecting terminal of said voltage detector.

Preferably, the logic controller further determines if inputting voltage of the external battery device is higher than a third voltage threshold, and then the external battery device is electrically conducted to the portable system, or the internal battery device is electrically conducted to the portable system.

Preferably, the power path multiplexer switches the external battery device to conduct electrically to the portable system while the logic controller determines that input voltage of the external battery device restores to be higher than a fourth voltage threshold.

Certainly, the third voltage threshold can be lower than the fourth voltage threshold.

Preferably, the third voltage threshold is equal to S+0.3V, and the fourth voltage threshold is equal to S+0.4V, where S is defined via equation of S=VBAT_{EXT-ideal}×R4/(R3+R4), wherein VBAT_{EXT-ideal} is the ideal inputting voltage of said extended battery device, R3 is resistance between said extended battery device and said second connecting terminal of said voltage detector, and R4 is resistance between ground and said second connecting terminal of said voltage detector.

Preferably, the external power supply is provided to recharge the internal battery device while the external power supply has power larger than a power threshold; and the external power supply is provided to recharge the internal battery device and the external battery device simultaneously while the external power supply still has a power larger than a threshold.

Preferably, while external power supply is provided to recharge the internal battery device and external battery device, the internal battery device has higher recharging priority than external battery device.

Certainly, the logic controller can permit merely one of the external power supply, the internal battery device and the external battery device to electrically conduct to the portable system.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 illustrates an electrical circuit with external batteries for a computer according to the prior art;

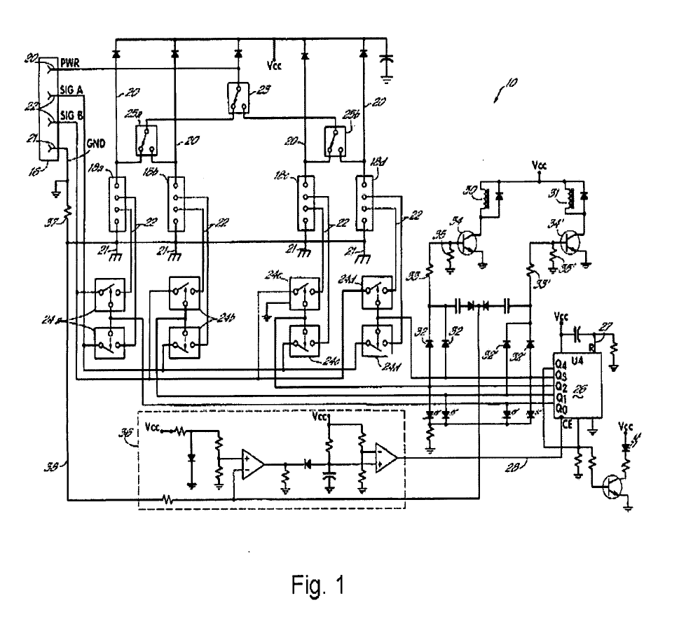

FIG. 2 illustrates a preferred embodiment of a battery-powered apparatus with an internal rechargeable battery and an external rechargeable battery for a portable system according to the present invention;

FIG. 3 illustrates a function block of a chargeable battery charging circuit according to the present invention;

FIG. 4 illustrates a flow chart of a chargeable battery charging mechanism according to the present invention;

FIG. 5 illustrates a function block of a power path switching circuit according to the present invention;

FIG. 6 illustrates a flow chart of a path switching mechanism according to the present invention; and

FIG. 7 illustrates another preferred embodiment of a battery-powered apparatus with an internal rechargeable battery and an external alkaline battery for a portable system according to the present invention.

### DETAILED DESCRIPTION OF THE PREFERRED EMBODIMENTS

The present invention discloses a battery-powered apparatus with an internal battery device and an external battery device, and the objects and advantages of the present invention will become more readily apparent to those ordinarily skilled in the art after reviewing the following detailed description. The present invention needs not be limited to the following embodiments.

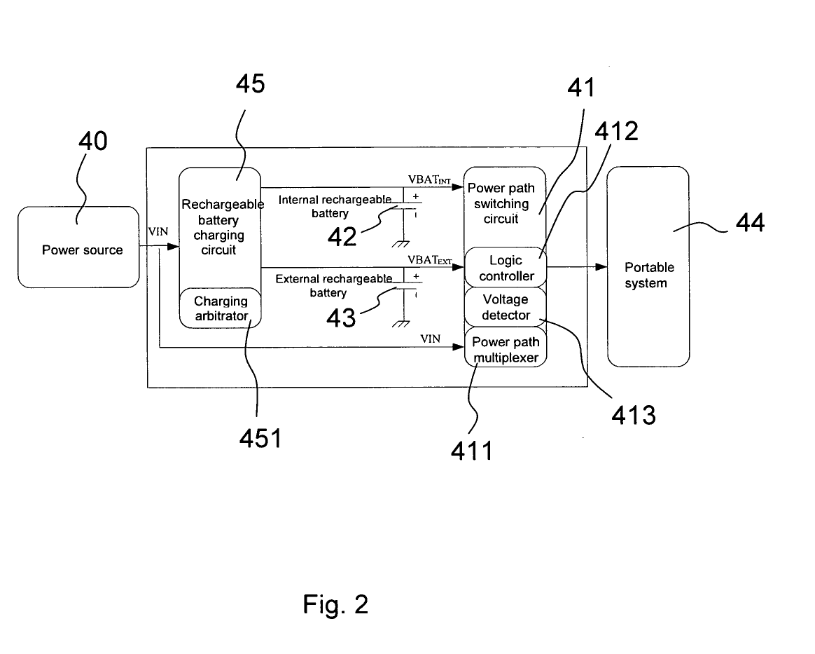

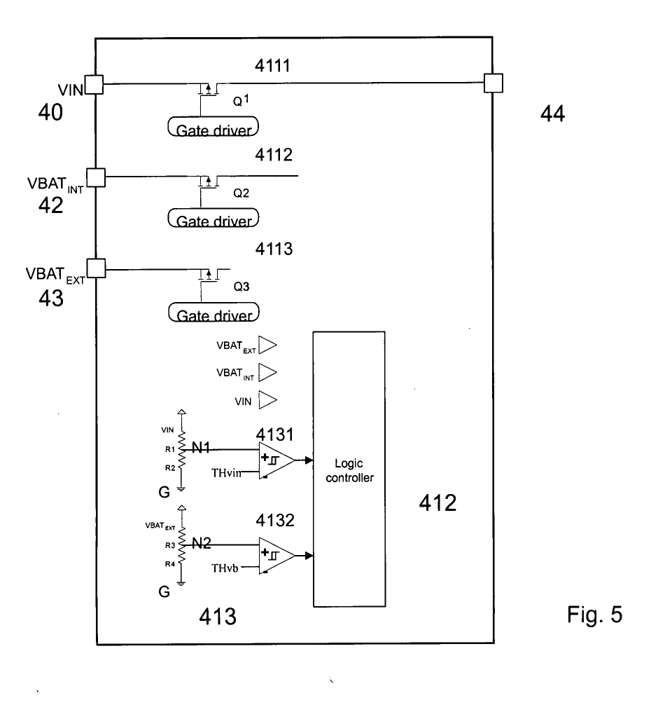

Please refer to FIG. 2. It illustrates a preferred embodiment of a battery-powered apparatus with an internal rechargeable battery and an external rechargeable battery for a portable system according to the present invention. As shown in FIG. 2, the battery-powered apparatus includes a power path switching circuit 41 and a rechargeable battery charging circuit 45. The power path switching circuit 41 has a power path multiplexer 411 with three switching device 4111-4113 (as shown in FIG. 5), a logic controller 412 and a voltage detector 413 with two comparators 4131-4132 (as shown in FIG. 5) connected to an external power source 40, an internal rechargeable battery 42, an external rechargeable battery 43 and the portable system 44. The voltage detector 413, in response to inputting voltages VIN, VBAT_{INT}, VBAT_{EXT} of the external power source 40, the internal rechargeable battery 42 and the external rechargeable battery 43, provides the logic controller 412 with information for determining which one of the external power source 40, the internal rechargeable battery 42 and the external rechargeable battery 43 is electrically conducted to the portable system 44 via the power path multiplexer 411.

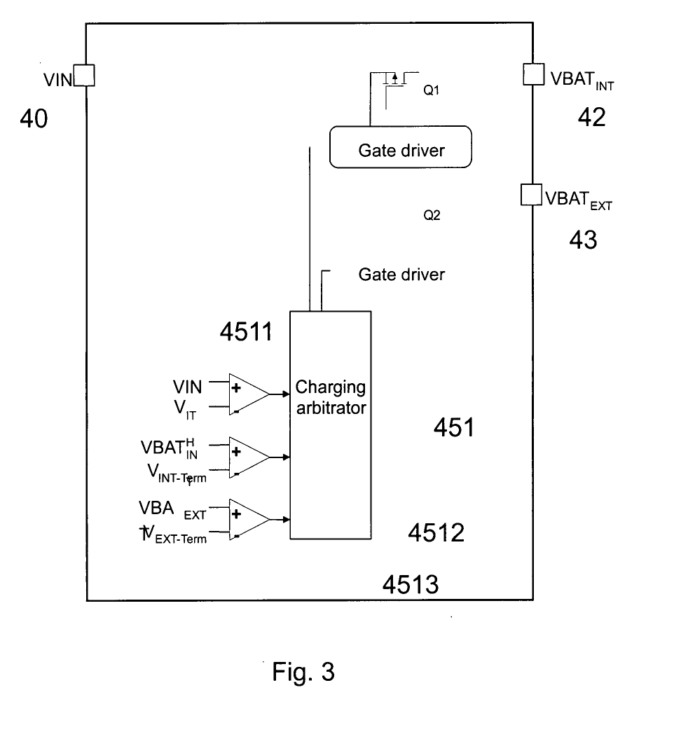

The rechargeable battery charging circuit 45 is connected to the external power source 40, the internal rechargeable battery 42, and the external rechargeable battery 43, and has a charging arbitrator 451 with three comparators 4511-4513 (as shown in FIG. 3) in response to the external power source 40, the internal rechargeable battery 42 and the external rechargeable battery 43 for determining to recharge the internal rechargeable battery 42 or the external rechargeable battery 43.

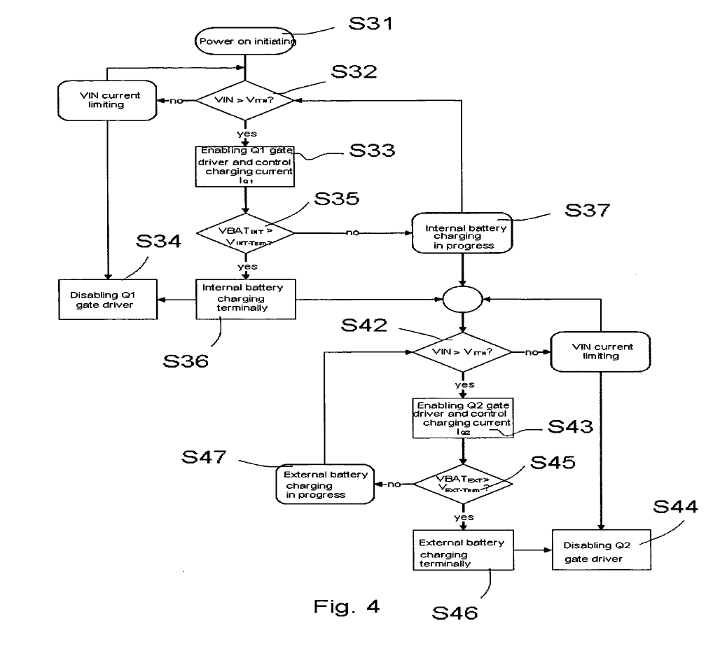

In practice, the external power source 40 is provided to recharge the internal chargeable battery 42 while the external power source 40 has power larger than a power threshold, and recharge the internal chargeable battery 42 and the external chargeable battery 43 simultaneously while the external power source 40 still has a power larger than a threshold. Please further refer to FIG. 3 and FIG. 4. They illustrate a function block of the chargeable battery charging circuit and a flow chart of a chargeable battery charging mechanism according to the present invention.

As shown in FIG. 3 and FIG. 4, the external power source 40 is initiated, as shown in step S31, and then the inputting voltage VIN of the external power source 40 is compared to the power threshold V_{ITH}, which is VIN low voltage threshold via the comparator 4511 of the charging arbitrator 451, as shown in step S32. If the inputting voltage VIN is higher than V_{ITH}, the charging arbitrator 451 will enable Q1 gate driver between the external power source 40 and the internal rechargeable battery 42 and control electric current I_{Q1} thereof, as shown in step S33. Otherwise, Q1 gate driver will be disabled, as shown in step S34.

Furthermore, inputting voltage VBAT_{INT} of the internal rechargeable battery is compared to an internal battery terminal threshold V_{INT-TERM} via the comparator 4512 of the charging arbitrator 451, as shown in step S35. If the inputting voltage VBAT_{INT} is higher than V_{INT-TERM}, the recharging of the internal rechargeable battery is terminated, as shown in step S36, and then the Q1 gate driver is disabled. Otherwise, the internal rechargeable battery is recharged in progress, as shown in step S37.

Similarly, the inputting voltage VIN of the external power source 40 is further compared to the power threshold V_{ITH}, which is VIN low voltage threshold via the comparator 4511 of the charging arbitrator 451, as shown in step S42. If the inputting voltage VIN is still higher than V_{ITH}, the charging arbitrator 451 will enable Q2 gate driver between the external power source 40 and the external rechargeable battery 43 and control electric current I_{Q2} thereof, as shown in step S43. Otherwise, Q2 gate driver will be disabled, as shown in step S44.

Furthermore, the inputting voltage VBAT_{EXT} of the external rechargeable battery is compared to an external battery terminal threshold V_{EXT-TERM} via the comparator 4513 of the charging arbitrator 451, as shown in step S45. If the inputting voltage VBAT_{EXT} is higher than V_{EXT-TERM}, the recharging of the internal rechargeable battery is terminated, as shown in step S46, and then the Q2 gate driver is disabled. Otherwise, the external rechargeable battery is recharged in progress, as shown in step S47.

Accordingly, the external power source is provided to recharge the internal rechargeable battery while the external power source has power larger than a power threshold, and recharge both of the internal rechargeable battery and the external rechargeable battery simultaneously while the external power supply still has a power larger than the threshold. Certainly, the gate driver enable priority is Q1>Q2.

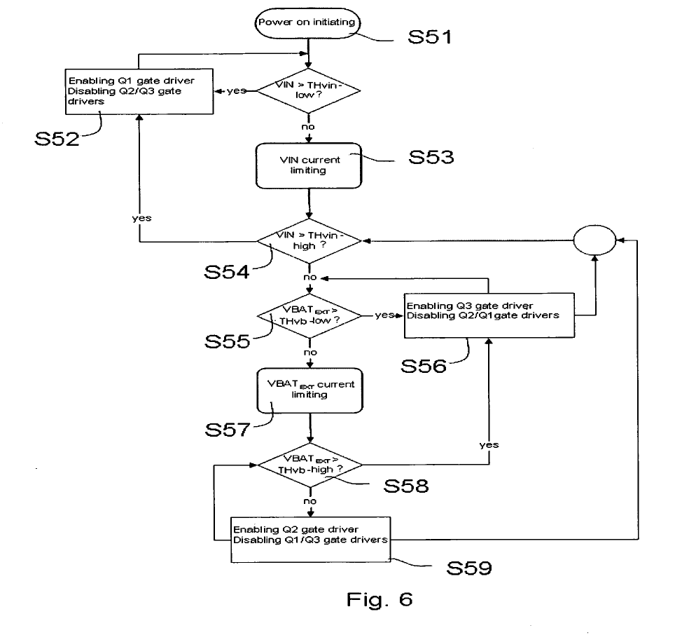

Moreover, referring to FIG. 5 and FIG. 6, they illustrate a function block of a power path switching circuit with two comparators and a flow chart of a power path switching mechanism according to the present invention. The external power source 40 is initiated as shown in step S51. The external power source 40 is electrically conducted to the portable system directly while input voltage VIN of the external power source 40 is higher than a first voltage threshold THvin-low (THvin-low=K+0.3V). Then Q1 gate driver is enabled and Q2/Q3 gate driver is disabled as shown in step S52. Otherwise, VIN current is limited as shown in step S53, wherein the internal rechargeable battery 42 or the external rechargeable battery 43 is electrically conducted to the portable system 44.

In the circuit of the present invention, the voltage detector further includes a first connecting terminal N1 for connecting to inputting voltage VIN of the external power source 40 and ground G; and a second connecting terminal N2 for connecting to inputting voltage VBAT_{EXT} of the external rechargeable battery 43 and ground G. Meanwhile, the above K value is adjustable according to the peripheral circuit thereof. Specially, the K value of the present invention is defined via equation of K=VIN_{ideal}×R2/(R1+R2), where VIN_{ideal} is the ideal inputting voltage of the external power source 40, R1 is resistance between the external power supply and the first connecting terminal N1 of the voltage detector, and R2 is resistance between ground G and the first connecting terminal N1 of the voltage detector.

Furthermore, as shown in step S54, the logic controller will keep determining if the inputting voltage VIN of the external power resource restores to be higher than a second voltage threshold THvin-high (THvin-high=K+0.4V) via the comparator 4131 of the voltage detector of the power path switching circuit. If VIN>THvin-high, the power path multiplexer will switch the external power source 40, instead of the internal rechargeable battery 42 or the external rechargeable battery 43, to conduct electrically to the portable system 44, back to the step S52.

Additionally, when VIN is lower than THvin-low, the logic controller will further determine if the inputting voltage VBAT_{EXT} of the external rechargeable battery 43 is higher than a third voltage threshold THvb-low (THvb-low=S+0.3V) via the comparator 4132 of the voltage detector of the power path switching circuit, as shown in step S55. Similarly, the above S value is adjustable according to the peripheral circuit thereof. Specially, the S value of the present invention is defined via equation of S=VBAT_{EXT-ideal}×R4/(R3+R4), where VBAT_{EXT} is the ideal inputting voltage of the extended battery device, R3 is resistance between the external rechargeable battery and the second connecting terminal N2 of the voltage detector, and R4 is resistance between ground G and the second connecting terminal N2 of the voltage detector. When VBAT_{EXT} is higher than THvin-low, the external rechargeable battery 43 is electrically conducted to the portable system 44 as shown in step S56, and then Q3 gate driver is enabled and Q2/Q1 gate driver is disabled. Or else VBAT_{EXT} current is limited as shown in step S57, wherein the internal rechargeable battery 42 is electrically conducted to the portable system 44, as shown in step S59.

Furthermore, as shown in step S58, the logic controller will keep determining if the inputting voltage VBAT_{EXT} of the external rechargeable battery 43 restores to be higher than a fourth voltage threshold THvb-high (THvb-high=S+0.4V) via the comparator 4132 of the voltage detector of the power path switching circuit. If VBAT_{EXT}>THvb-high, the power path multiplexer will switch the external rechargeable battery 43, instead of the internal rechargeable battery 42, to conduct electrically to the portable system 44, back to the step S56.

As discussed above, the values of THvin-low, THvin-high, THvb-low and Thvb-high are defined for avoiding a ripple effect and a gray zone of analogic circuit, where K and S are dependent on inputting voltage of the external power source, the external battery device, and peripheral resistance thereof, respectively. Accordingly, the battery-powered apparatus will provide the portable system with power, such that the external power source has higher priority than the external rechargeable battery, and the external rechargeable battery has higher priority than the internal rechargeable battery.

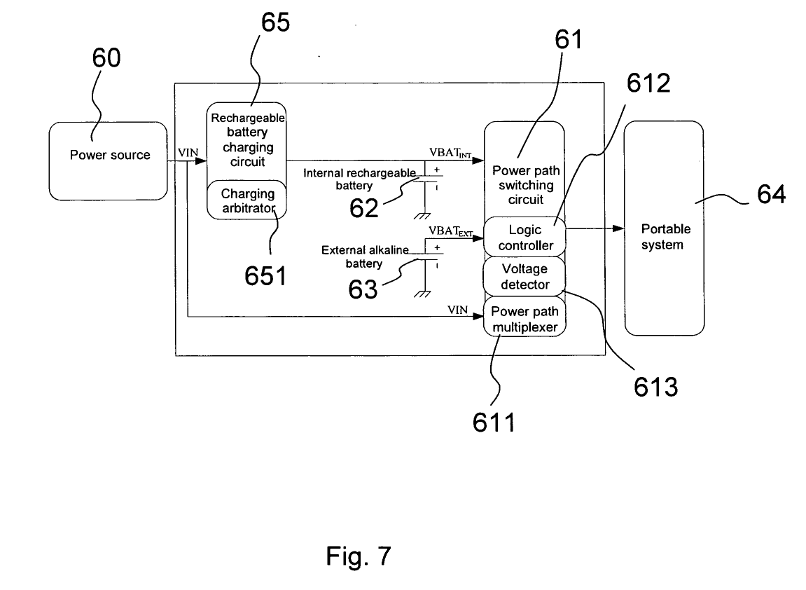

Please refer to FIG. 7. It illustrates another preferred embodiment of a battery-powered apparatus with an internal rechargeable battery and an external alkaline battery for a portable system according to the present invention. As shown in FIG. 7, the battery-powered apparatus includes a power path switching circuit 61 and a rechargeable battery charging circuit 65. The power path switching circuit 61 has a power path multiplexer 611, a logic controller 612 and a voltage detector 613 connected to an external power source 60, an internal rechargeable battery 62, an external alkaline battery 63 and the portable system 64. The voltage detector 613, in response to inputting voltages VIN, VBAT_{INT}, VBAT_{EXT} of the external power source 60, the internal rechargeable battery 62 and the external alkaline battery 63, provides the logic controller 612 with information for determining which one of the external power source 60, the internal rechargeable battery 62 and the external alkaline battery 63 is electrically conducted to the portable system 64 via the power path multiplexer 611. The rechargeable battery charging circuit 65 is connected to the external power source 60, and the internal rechargeable battery 62 and has a charging arbitrator 651 in response to the external power source 60 and the internal rechargeable battery 62 for determining to recharge the internal rechargeable battery 62 or not. The embodiment of FIG. 7 is simpler than that of FIG. 2. According to the above descriptions, although the external alkaline battery 63 is not a rechargeable battery, the battery-powered apparatus also provides the portable system 64 with power, such that the external power source 60 has higher priority than the external alkaline battery 63, and the external alkaline battery 63 has higher priority than the internal rechargeable battery 62. The rechargeable battery charging circuit 65 works for the internal rechargeable battery 62 merely.

In conclusion, the present invention provides a battery-powered apparatus with an internal battery device and an external battery device for a portable system, wherein a rechargeable battery charging circuit and a power path switching circuit are introduced, thereby providing the portable system with a stable power source, and recharging the battery-powered apparatus stably.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A battery powered apparatus for a portable system, comprising:
a power path switching circuit having a power path multiplexer, a logic controller and a voltage detector connected to an external power supply, an internal battery device, an external battery device and said portable system, wherein in response to inputting voltages of said external power supply, said internal battery device and said external battery device, said voltage detector commands said logic controller to determine which one of said external power supply, said internal battery device and said external battery device is electrically conducted to said portable system via said power path multiplexer; and
a rechargeable battery charging circuit, connected to said external power supply, said internal battery device, and said external battery device, having a charging arbitrator in response to said external power supply, said internal battery device and said external battery device for determining to recharge said internal battery device or said external battery device.

2. The battery powered apparatus according to claim 1, wherein said external power supply is electrically conducted to said portable system while input voltage of said external power supply is higher than a first voltage threshold, and one of said internal battery device and said external battery device is electrically conducted to said portable system while input voltage of said external power supply is lower than said first voltage threshold.

3. The battery powered apparatus according to claim 2, wherein said power path multiplexer switches said external power supply to conduct electrically to said portable system while said logic controller determines that input voltage of said external power supply restores to be higher than a second voltage threshold.

4. The battery powered apparatus according to claim 3, wherein said first voltage threshold is lower than said second voltage threshold.

5. The battery powered system according to claim 1, wherein said voltage detector further comprises a first connecting terminal for connecting to said external power supply and ground, and a second connecting terminal for connecting to said external battery device and ground.

6. The battery powered system according to claim 5, wherein said first voltage threshold is substantially equal to K+0.3V, and said second voltage threshold is substantially equal to K+0.4V, where K=VIN×R2/(R1+R2), VIN is the ideal inputting voltage of said external power supply, R1 is resistance between said external power supply and said first connecting terminal of said voltage detector, and R2 is resistance between ground and said first connecting terminal of said voltage detector.

7. The battery powered system according to claim 1, wherein said logic controller further determines if inputting voltage of said external battery device is higher than a third voltage threshold, and then said external battery device is electrically conducted to said portable system, or said internal battery device is electrically conducted to said portable system if inputting voltage of said external battery device is lower than said third voltage.

8. The battery powered apparatus according to claim 7, wherein said power path multiplexer switches said external battery device to conduct electrically to said portable system while said logic controller determines that input voltage of said external battery device restores to be higher than a fourth voltage threshold.

9. The battery powered apparatus according to claim 8, wherein said third voltage threshold is lower than said fourth voltage threshold.

10. The battery powered apparatus according to claim 9, wherein said third voltage threshold is substantially equal to S+0.3V, and said fourth voltage threshold is substantially equal to S+0.4V, where S is defined via equation of S=VBAT_{EXT}×R4/(R3+R4), wherein VBAT_{EXT} is the ideal inputting voltage of said external battery device, R3 is resistance between said external battery device and said second connecting terminal of said voltage detector, and R4 is resistance between ground and said second connecting terminal of said voltage detector.

11. The battery powered apparatus according to claim 1, wherein said external power supply is provided to recharge said internal battery device while said external power supply has a power larger than a threshold.

12. The battery powered apparatus according to claim 1, wherein said external power supply is provided to recharge said internal battery device and said external battery device while said external power supply has a power larger than a threshold.

13. The battery powered apparatus according to claim 12, wherein recharging priority of said internal battery device is higher than that of said external battery device.

14. The battery powered apparatus according to claim 1, wherein said logic controller permits merely one of said external power supply, said internal battery device and said external battery device to electrically conduct to said portable system.

15. A battery powered apparatus for a portable system, comprising:
a power path switching circuit having a power path multiplexer, a logic controller and a voltage detector connected to an external power supply, an internal battery device, an external battery device and said portable system, wherein in response to inputting voltages of said external power supply, said internal battery device and said external battery device, said voltage detector commands said logic controller to determine which one of said external power supply, said internal battery device and said external battery device is electrically conducted to said portable system via said power path multiplexer; and
a rechargeable battery charging circuit, connected to said external power supply and said internal battery device, for recharging said internal battery device.

16. The battery powered apparatus according to claim 15, wherein said external power supply is provided to recharge said internal battery device while said external power supply has a power larger than a threshold.

17. The battery powered apparatus according to claim 15, wherein power-supplying priority of said external power supply is higher than that of said external battery device.

18. The battery powered apparatus according to claim 15, wherein power-supplying priority of said external battery device is higher than that of said internal battery device.

19. The battery powered apparatus according to claim 15, wherein said logic controller permits merely one of said external power supply, said internal battery device and said external battery device to electronically conduct to said portable system.
